(19) United States
(12) Patent Application Publication
(10) Pub. No.: US 2026/0357790 A1
(43) Pub. Date: Nov. 12, 2026

(54) WIND TURBINE BLADE TORSION MEASURING SYSTEMS

(71) Applicant: LM Wind Power A/S, Kolding (DK)

(72) Inventor: Andreas Herrig, Garching (DE)

(21) Appl. No.: 19/121,546

(22) PCT Filed: Oct. 20, 2023
(86) PCT No.: PCT/EP2023/079234

§ 371 Date: Apr. 16, 2025

(30) Foreign Application Priority Data
Oct. 21, 2022 (EP) 22203050.4

(51) Int. Cl. F03D 17/00

(52) U.S. Cl. CPC F03D 17/028; F05B 2270/804

(57) ABSTRACT

In a first aspect, a wind turbine blade torsion measuring system is provided. The wind turbine blade torsion measuring system comprises a shaft, a rotary sensor assembly and a connecting structure. The connecting structure is configured to movably connect the rotary sensor assembly to a blade structure to allow a relative movement between the rotary sensor assembly and the blade structure in a direction substantially parallel to the spanwise direction of the wind turbine blade. In a further aspect, a wind turbine blade comprising one or more wind turbine blade torsion measuring systems is provided. In yet a further aspect, a method of determining the torsional deformation of this wind turbine blade is provided. In yet a further aspect, a method for mounting the wind turbine blade torsion measuring system in a wind turbine blade is provided.

The present disclosure relates to wind turbine blade torsion measuring systems, wind turbine blades having a wind turbine blade torsion measuring system, methods for determining a twisting of the wind turbine blades and methods for mounting wind turbine blade torsion measuring systems in wind turbine blades.

### BACKGROUND

Modern wind turbines are commonly used to supply electricity to the electrical grid. Wind turbines of this kind generally comprise a rotor with a rotor hub and a plurality of blades. The rotor is set into rotation under the influence of the wind on the blades. The rotation of the rotor shaft drives the generator rotor either directly (“directly driven”) or through the use of a gearbox. The gearbox (if present), the generator, and other systems are usually mounted in a nacelle on top of a wind turbine tower.

An auxiliary system generally provided on wind turbines is the pitch system. Pitch systems are employed for adapting the position of a wind turbine blade to varying wind conditions. A pitch system normally comprises a pitch bearing comprising an outer ring, an inner ring and, between these two rings, one or more rows of rolling elements which allow both rings to rotate relative to each other.

A wind turbine blade may be attached either at the inner ring or at the outer ring, whereas the hub is connected at the other of the rings. A blade may perform a relative rotational movement with respect to the hub when a pitch system is actuated. The bearing inner ring may therefore perform a rotational movement with respect to the bearing outer ring.

Wind turbine blades have a root portion to be attached to the rotor hub (through the pitch bearing) and a tip portion at an opposite end. The root portion of the wind turbine blade usually has a generally round cross-section. Some other regions such as a profiled or an airfoil portion that is furthest away from the rotor hub, have a cross-section with an aerodynamic profile. The aerodynamic sections that form the aerodynamic profile may be twisted towards the tip, i.e. the angle of the profile chord changes towards the tip. The angle of attack at different aerodynamic sections may thus vary along the length of the wind turbine blade. Relative wind speed experienced by the wind turbine blade at different aerodynamic sections thus depends on the angle of attack.

As the wind experienced by the wind turbine blade causes pressure loads on the profiles which are not acting in the same location for all conditions, the blade experiences a torsional load. These torsional loads may induce a torsional or induced twisting deformation of the blade. A torsional or twisting deformation of the blade changes the angle of the profile chord along the length of the blade and by this the loading of the blade. The aerodynamic performance of the blade may thus be adversely affected. This may result in a reduction in power generation. Furthermore, the torsional deformation of the blade may increase the noise generated by the wind turbine. In addition, large wind turbines may generally be subjected to greater torsional or twisting deformation, which can also imply challenges to operate them in a stable way without oscillations of the blades and the whole turbine.

Strain gauges may be used to measure the torsional deformation of the blade. However, measurements provided by these strain gauges may not be accurate and have a great dependency on the bending of the blade. Calibrating these strain gauges for different loading situations to determine torsion is also time-consuming and difficult.

A camera may alternatively be used to detect the angular position of the blade by detecting markers arranged on the blade. However, these markers are not visible depending on the angle of the wind turbine blade. For example, due to the bending of the blade, markers arranged on a suction side of the blade are not always visible from a camera arranged at the blade root, the tower or at the nacelle. Dust or fog and clouds can also impact visibility. Accordingly, these types of systems can only be used at specific times. Also, the processing of the images may not be feasible in real-time, but rather a post-processing step with a significant delay.

Rotary sensors that measure the rotation of the blade relative to a reference element have also been proposed. However, the reference element and/or the supports of the rotary sensors may be greatly dependent on the bending deformation of the blade. The reference element may also be subjected to axial deformations, e. g due to thermal expansion or bending. These bending and axial deformations may cause the rotary sensor to provide measurement errors. Furthermore, mounting these systems inside a wind turbine blade may be difficult.

The present disclosure provides examples of systems and methods that at least partially resolve some of the aforementioned disadvantages.

### SUMMARY

In a first aspect, a wind turbine blade torsion measuring system is provided. The wind turbine blade torsion measuring system comprises a shaft configured to be arranged in a direction substantially parallel to the spanwise direction of the wind turbine blade. The shaft comprises a first shaft portion configured to be coupled to a blade structure of the wind turbine blade. The wind turbine blade torsion measuring system further comprises a rotary sensor assembly having a rotating component rigidly connected to the first shaft portion, a fixed component rotatably connected to the rotating component and a sensor to determine a rotational movement of the rotating component relative to the fixed component. In addition, the wind turbine blade torsion measurement system comprises a connecting structure configured to movably connect the rotary sensor assembly to the blade structure to allow a relative movement between the rotary sensor assembly and the blade structure in a direction substantially parallel to the spanwise direction of the wind turbine blade.

In this disclosure, a movable connection between the rotary sensor assembly and the blade structure shall be understood as a connection allowing a relative movement in a direction substantially parallel to the spanwise direction of the wind turbine blade between the rotary sensor assembly and the blade structure. A movable connection may comprise a slidable connection or a flexible connection in the spanwise direction of the wind turbine blade.

According to this aspect, axial movements, i.e. movements substantially parallel to the spanwise direction of the wind turbine blade, and position changes of the shaft relative to the wind turbine blade may be compensated by the connecting structure. For example, these axial movements and position changes of the shaft may be caused by the bending of the blade and/or by thermal deformations. These phenomena are generally more pronounced in large wind turbine blades because they are subjected to greater loads and are relatively more flexible, but also longer. Consequently, according to this aspect, the negative effect of bending deformations experienced by the wind turbine blade on the precision of the torsional measurements may be reduced. Relative changes in the structural behavior between the wind turbine blade and the shaft may be absorbed and compensated by the connecting structure.

Loads applied to the rotary sensor are additionally reduced. Accordingly, the expected lifetime of the measurement system may thus be increased. Furthermore, as the deformations are at least partly compensated, the wind turbine blade torsion measuring system may be arranged out of the flapwise and/or edgewise neutral axis. This expands the installation possibilities of the wind turbine blade torsion measuring system while maintaining the accuracy of the measurements.

In a further aspect, a wind turbine blade comprising one or more wind turbine blade torsion measuring systems according to any of the examples herein disclosed is provided.

In a yet further aspect, a method of determining a torsional deformation of the wind turbine blade according to any of the examples herein disclosed is provided. This method comprises determining a rotational movement of the rotating component relative to the fixed component of the corresponding rotary sensor assembly and outputting a signal indicative of the determined rotational movement to a controller or data acquisition system.

In yet a further aspect, a method for mounting the wind turbine blade torsion measuring system in a wind turbine blade is provided. This method comprises connecting the rotary sensor assembly to the connecting structure and rigidly connecting the rotating component of the rotary sensor assembly to the first shaft portion. The method further comprises inserting the shaft within a wind turbine blade and connecting the connecting structure to the blade structure.

Advantages derived from these aspects may be similar to those mentioned regarding the first aspect.

### BRIEF DESCRIPTION OF THE DRAWINGS

Non-limiting examples of the present disclosure will be described in the following, with reference to the appended drawings, in which:

FIG. 1 illustrates a perspective view of a wind turbine according to one example;

FIG. 2 illustrates a simplified, internal view of a nacelle of a wind turbine according to one example;

FIG. 3 shows a perspective view of a wind turbine blade according to one example;

FIG. 4 shows a cross-sectional view of the wind turbine blade of FIG. 3;

FIG. 5 schematically represents a wind turbine blade torsion measuring system according to an example of the present disclosure;

FIG. 6 schematically represents a wind turbine blade torsion measuring system according to an example of the present disclosure;

FIG. 7a-7f schematically represent examples of a rotary sensor assembly and a connecting structure according to the present disclosure;

FIG. 8 schematically represents a sensor plate according to any of the examples herein disclosed;

FIG. 9 schematically represents a wind turbine blade torsion measuring system according to an example of the present disclosure;

FIGS. 10a-10d schematically represent examples of wind turbine blades having a plurality of wind turbine blade torsion measuring systems according to the present disclosure;

FIG. 11 is a block diagram of a method of determining a torsional deformation of a wind turbine blade comprising one or more wind turbine blade torsion measuring systems according to an example of the present disclosure; and

FIG. 12 is a block diagram of a method for mounting a wind turbine blade torsion measurement system in a wind turbine blade according to an example of the present disclosure.

### DETAILED DESCRIPTION OF EXAMPLES

In these Figures, the same reference signs have been used to designate matching elements.

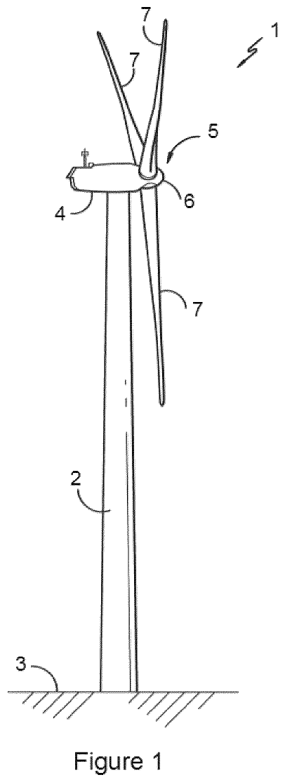

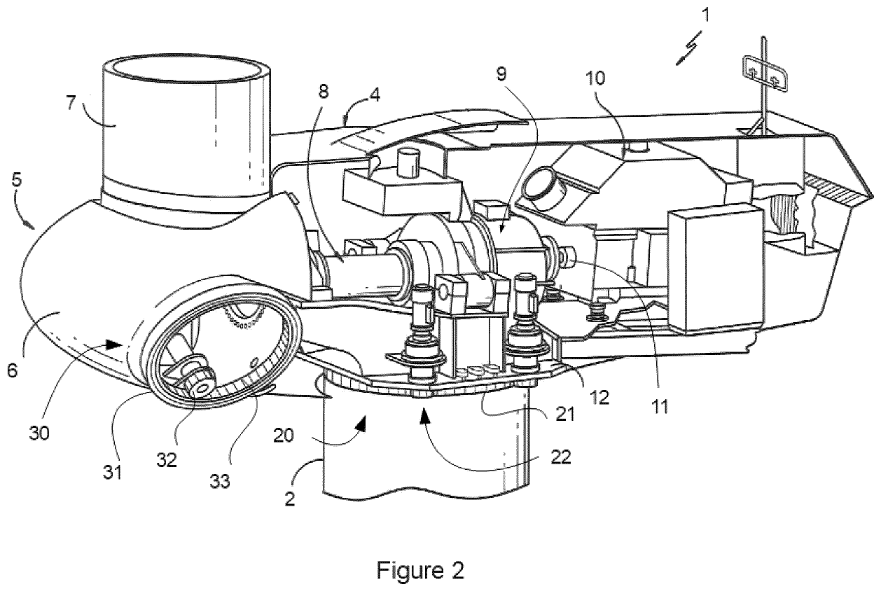

FIG. 1 illustrates a perspective view of one example of a wind turbine 1. As shown, the wind turbine 1 includes a tower 2 extending from a support surface 3, a nacelle 4 mounted on the tower 2, and a rotor 5 coupled to the nacelle 4. The rotor 5 includes a rotatable hub 6 and at least one wind turbine blade 7 coupled to and extending outwardly from the rotor hub 6. For example, in the illustrated example, the rotor 5 includes three wind turbine blades 7. However, in an alternative embodiment, the rotor 5 may include more or less than three blades 7. Each wind turbine blade 7 may be spaced from the rotor hub 6 to facilitate rotating the rotor 5 to enable kinetic energy to be transferred from the wind into usable mechanical energy, and subsequently, electrical energy. For instance, the rotor hub 6 may be rotatably coupled to an electric generator 10 (FIG. 2) positioned within the nacelle 4 or forming part of the nacelle to permit electrical energy to be produced.

FIG. 2 illustrates a simplified, internal view of one example of the nacelle 4 of the wind turbine 1 of FIG. 1. As shown, the electric generator 10 may be disposed within the nacelle 4. In general, the generator 10 may be coupled to the rotor 5 of the wind turbine 1 for generating electrical power from the rotational energy generated by the rotor 5. For example, the rotor 5 may include a main rotor shaft 8 coupled to the hub 6 for rotation therewith. The generator 10 may then be coupled to the rotor shaft 8 such that the rotation of the rotor shaft 8 drives the generator 10. For instance, in this figure, the generator 10 includes a generator shaft 11 rotatably coupled to the rotor shaft 8 through a gearbox 9. In other examples, the generator may be directly coupled to the rotor hub or to the rotor shaft.

It should be appreciated that the rotor shaft 8, gearbox 9, and generator 10 may generally be supported within the nacelle 4 by a bedplate or a support frame 12 positioned atop the tower 2.

The nacelle 4 is rotatably coupled to the tower 2 through a yaw system 20. The yaw system comprises a yaw bearing (not visible in FIG. 2) having two bearing components configured to rotate with respect to the other. The tower 2 is coupled to one of the bearing components and the bedplate or support frame 12 of the nacelle 4 is coupled to the other bearing component. The yaw system 20 comprises a yaw annular gear 21 and a plurality of yaw drives 22 with a motor, a gearbox and a pinion for meshing with the annular gear for rotating one of the bearing components with respect to the other.

Blades 7 are coupled to the rotor hub 6 with a pitch bearing 31 in between the blade 7 and the rotor hub 6. The pitch bearing 31 comprises an inner ring and an outer ring (shown). A wind turbine blade may be attached either to the inner bearing ring or to the outer bearing ring, whereas the hub is connected to the other. A blade 7 may perform a relative rotational movement with respect to the rotor hub 6 when a pitch system 30 is actuated. The inner bearing ring may therefore perform a rotational movement with respect to the outer bearing ring. The pitch system 30 of FIG. 2 comprises a pinion 32 that meshes with a pitch annular gear 33 provided on the inner bearing ring to set the wind turbine blade into rotation.

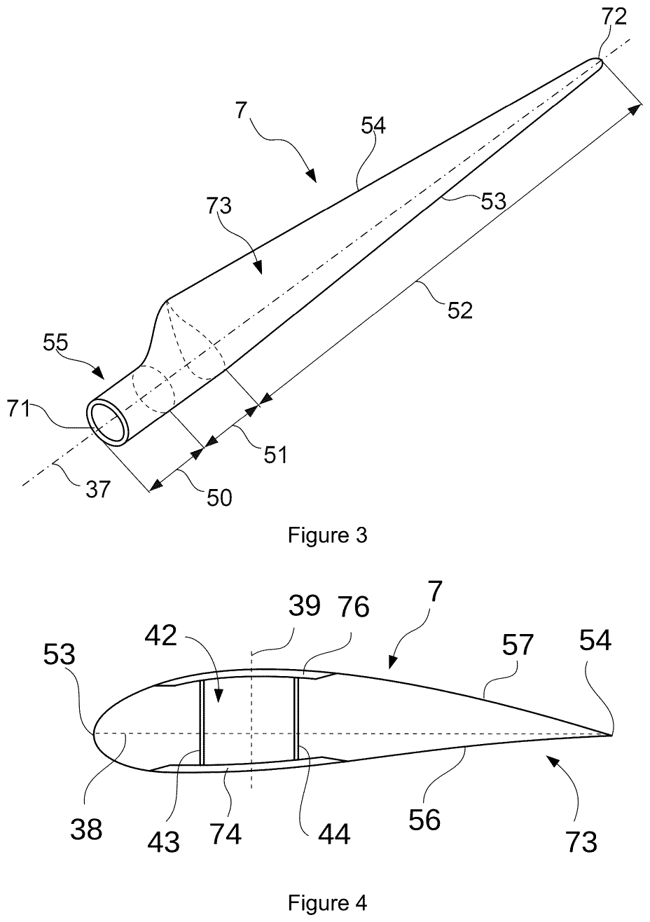

FIG. 3 illustrates an example of a wind turbine blade 7. The wind turbine blade 7 extends in a longitudinal direction or spanwise direction 37 from a blade root end 71 to a blade tip end 72. The blade 7 comprises a blade root region or portion 50 closest to the rotor hub, a profiled or an airfoil portion 52 furthest away from the rotor hub and a transition portion 51 between the blade root portion 50 and the airfoil portion 52. The blade 7 comprises a leading edge 53 facing the direction of rotation of the blade 7 when mounted on the rotor hub, and a trailing edge 54 facing the opposite direction of the leading edge 53.

In the disclosed examples herein, the length of the wind turbine blade 7 from the blade root end 71 to the blade tip end 72 is above 80 meters, for instance, above 100 meters. However, wind turbine blades 7 of any length may be used as well.

The airfoil portion 52 has a shape designed to generate lift, whereas the blade root portion 50 has a circular or elliptical cross-section for structural considerations and easy mounting of the blade to the rotor hub. The diameter or the chord of the blade root portion 50 may be constant along the entire blade root portion 50. At the transition portion 51, the profile gradually changes from the circular or elliptical cross-section of the blade root portion 50 to the airfoil profile of the airfoil portion 52.

The wind turbine blade 7 comprises a blade shell 73. The blade shell may comprise two blade shell parts, for example, a pressure side blade shell and a suction side blade shell. The pressure side blade shell may be joined, e.g. glued or bonded, to the suction side blade shell along joining lines along the leading edge 53 and the trailing edge 54. The blade shell 73 comprises an outer side or surface that defines the external shape of the blade, e.g. the outer shape at the blade root portion and the outer shape at the airfoil portion. The blade shell 73 also comprises an inner side or surface that defines the internal volume of the blade and faces a load-carrying structure (not shown). The blade shell 73 may be made of fiber-reinforced polymer, e.g. glass fiber and/or carbon fiber.

FIG. 4 shows a cross-sectional view of the wind turbine blade of FIG. 3. A suction side 57 and a pressure side 56 extend from the leading edge 53 to the trailing edge 54. The wind turbine blade 7 further comprises a chord line 38 between the leading edge 53 and the trailing edge 54. The chord line 38 extends in an edgewise direction. A flapwise direction 39 is substantially perpendicular to the chord line 38.

Although not shown in these figures, the wind turbine blade 7 may be slightly twisted by design. A blade twist refers to a change of the chord line 38 from the blade root portion 50 to the blade tip end 72. This blade twist optimizes the angle of attack and, consequently, optimizes the lift along the span of the blade. For example, the wind turbine blade may be twisted by an angle between 5-20 degrees from the root to the tip, i.e. the chord line at the root portion and the chord line in a region adjacent to the blade tip end forms an angle between 5-20 degrees. Loads acting on the wind turbine blade may generate torsional loads. These torsional loads may cause a torsional deformation of the wind turbine blade. The wind turbine blade may thus be twisted or torsionally deformed about the spanwise direction.

The wind turbine blade 7 comprises a blade structure that provides stiffness to the wind turbine blade. The blade structure of this example comprises the blade shell 73 and a load-carrying structure. In further examples, the blade structure may also comprise a plurality of structural ribs arranged along the length of the blade. In this example, the load-carrying structure comprises shear webs, such as a leading edge shear web 43 and a trailing edge shear web 44. A cavity 42 is defined between the leading edge shear web 43 and the trailing edge shear web 44. The cavity 42 may extend throughout a length along the spanwise direction. The load-carrying structure of this figure also comprises a pressure side spar cap 74 arranged at the pressure side 56 and a suction side spar cap 76 at the suction side 57. In some examples, the shear webs 43 and 44 could be a spar box with spar sides, such as a trailing edge spar side and a leading edge spar side.

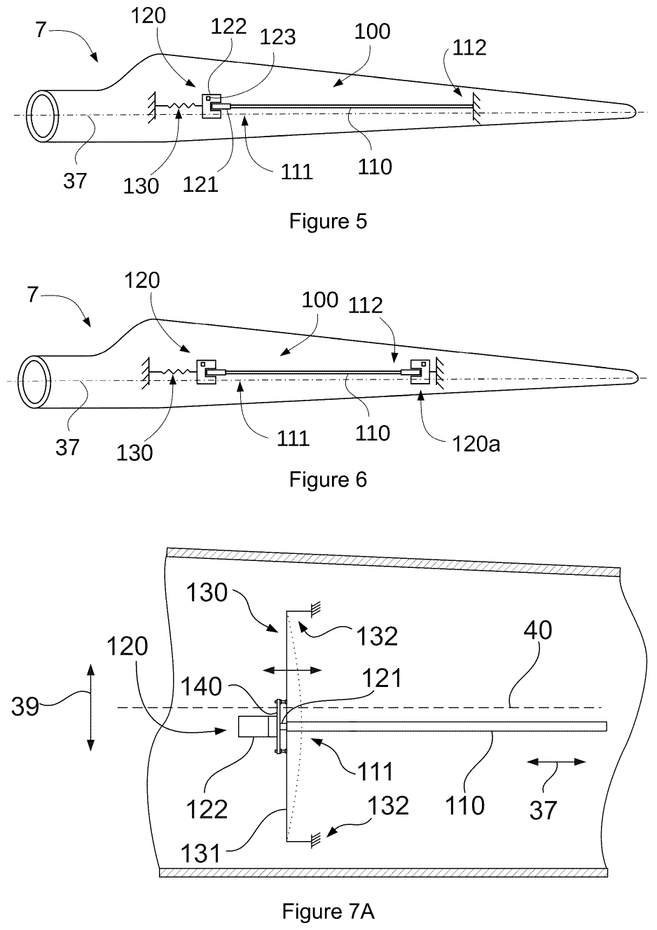

FIG. 5 schematically represents a wind turbine blade torsion measuring system 100 according to an example of the present disclosure. The wind turbine blade torsion measuring system 100 is arranged within a wind turbine blade 7.

The wind turbine blade torsion measuring system 100 of this figure comprises a shaft 110 arranged within a wind turbine blade 7 in a direction substantially parallel to the spanwise direction 37 of the wind turbine blade. In some examples, e.g. in swept blades, substantially parallel to the spanwise direction 37 of the wind turbine blade may include parallel to the fibres direction of the spar cap laminates.

In some examples, the shaft may be hollow to reduce the overall weight of the blade. The shaft may be manufactured from lightweight and non-conducting materials, e.g. from composites comprising glass fiber and Kevlar. The shaft may comprise both axial and inclined fibers, e.g. arranged at 45°. These inclined fibers increase the torsional stiffness of the shaft. Torsional deformation of the shaft may thus be minimized. In some examples, the shaft may comprise biaxial fibers, e.g. at a 30° angle, to provide both bending and torsional stiffness. In some examples, the shaft may comprise a diameter between 15 mm and 35 mm, e.g. between 20 mm and 30 mm.

The shaft 110 of this example comprises a first shaft portion 111 and a second shaft portion 112. The second shaft portion 112 of this figure is fixedly coupled to a blade structure of the wind turbine blade 7. The blade structure may be a shear web (for example, a shear web such as shear webs 43, 44 described above) or a bulkhead rib closing the cross-section of the blade. The second shaft portion 112 may be rigidly attached to an inner side of a leading edge shear web or to the inner side of a trailing edge shear web. The shaft may thus extend a length along the cavity defined between the leading edge shear web and the trailing edge shear web. The second shaft portion may be coupled to a blade structure arranged at a region of the half of the blade closest to the blade tip end, e.g. at the outermost third portion of the wind turbine blade.

In further examples, the blade structure may comprise a balance box or chamber arranged between the pressure and the suction side at a predetermined position in the lengthwise direction. Balance boxes or chambers are chambers filled with a material to adjust the static moment of the blade. In these examples, the second shaft portion 112 may be rigidly connected to a balance box. For example, the second shaft portion 112 may be inserted into a balance box. Glue may be used to attach the shaft portion 112 to the balance box.

In this example, as the second shaft portion 112 is rigidly coupled to the blade structure, the torsional deflection of the blade 7 induces a rotation of the shaft 110.

The first shaft portion 111 is rigidly connected to a rotating component 121 of a rotary sensor assembly 120. The rotating component 121 is rotatably connected to the fixed component 122 of the rotary sensor assembly 120. Accordingly, the rotation of the shaft 110 caused by the torsional deflection of the blade does not cause the fixed component 122 to rotate. The rotating component 121 and the fixed component 122 thus form a bearing arrangement. The rotating component 121 may comprise an inner bearing ring and the fixed component may comprise an outer bearing ring. Roller elements, e.g. ball bearings, may be arranged between the rotating component and the fixed component. Ball bearings may be manufactured from non-metallic materials, e.g. plastic, glass or ceramic.

The rotary sensor assembly 120 of this example further comprises a sensor 123 to determine a rotational movement of the rotating component 121 relative to the fixed component 122. The rotation of the rotating component 121 relative to the fixed component 122 indicates the rotation of the shaft 110 and, consequently, the torsional deflection of the blade 7. The torsional angle at the portion of the blade at which the second shaft portion 112 is rigidly coupled can thus be determined by the sensor 123.

In some examples, the rotary sensor assembly may comprise an absolute encoder. Compared to incremental encoders, the absolute encoders may allow determining the same absolute blade twist value after a system reset, since each rotating component position is associated with a specific mark or unique code. However, in some examples, the rotary sensor assembly may comprise an incremental encoder, if relative torsion changes during operation are sufficient.

In some examples, the sensor 123 may comprise an optical sensor. The rotating component may comprise a disk with a plurality of optical marks or codes. A transmitter may emit one or more light beams toward a receiver. The disk with the optical marks or codes is arranged between the transmitter and receiver. Accordingly, the number of light beams received by the receiver depends on the optical marks of the disk. The sensor may thus detect a specific optical mark and determine the angular position of the rotating component associated with this optical mark.

In some examples, the sensor may be a magnetic sensor. In these examples, the disk comprises magnetic poles and the sensor comprises a magnet. The variation of the magnetic field between the magnetic poles and the magnet provides the position of the disk relative to the magnet associated with the fixed component.

The rotary sensor assembly may be configured to output a signal indicative of the rotational movement of the rotating component relative to the fixed component. A controller, e.g. a wind turbine controller, may thus receive the outputted signal. The rotational deformation of the blade may be compared with an expected value for given conditions. Depending on the result, load mitigation strategies may then be applied to reduce the torsional deformation of the blade or take other measures on its operation or collect the data in a database used for further value optimizations of the turbine itself or other turbines in the farm or designed in the future.

The wind turbine blade torsion measuring system 100 of this example further comprises a connecting structure 130 movably connecting the rotary sensor assembly 120 to the blade structure of the blade 7 in a spanwise direction 37. The connecting structure 130 blocks the rotational movement of the rotary sensor assembly 120 and allows axial movements. The rotary sensor assembly 120 thus may move in a direction parallel to the spanwise direction while the rotary sensor assembly 120 is connected to the blade structure through the connecting structure 130. Accordingly, effects of bending and thermal expansion of the blade 7 and/or of the shaft 110 on the measurements obtained by the sensor 123 may be reduced.

In some examples, the connecting structure 130 comprises a guide rail extending in a direction substantially parallel to the spanwise direction 37 of the wind turbine blade 7. The guide rail may be rigidly connected to the blade structure, e.g. shear web. The rotary sensor assembly 120 may be configured to slide over the guide rail. The rotary sensor assembly 120 according to these examples can thus slide over the guide rail attached to the blade structure.

In some examples, the connecting structure 130 comprises a deformable portion or deformable elements. The shape of the deformable portion or of the deformable elements may change under the effect of a load. The deformation of the deformable portion or of the deformable elements may thus compensate for the dimensional variations of the shaft 110 and/or the blade 7. Examples of deformable elements may be springs connecting the rotary sensor assembly 120 to the blade structure.

The connecting structure 130 may comprise the deformable portion and an outer portion configured to be connected to the blade structure. The deformable portion may be connected to the rotary sensor assembly 120. The deformable portion may deform under a load in a direction parallel to the spanwise direction 37 of the wind turbine blade 7 so as to move the rotary sensor assembly 120 relative to the blade structure in a direction substantially parallel to the spanwise direction 37 of the wind turbine blade 7.

In some examples, the wind turbine blade torsion measuring system 100 may comprise one or more bearing supports to rotatably connect the shaft 110 to the blade structure. The bearing supports may be distributed at different positions of the length of the blade 7. The bearing supports may reduce the bending of the shaft 110. In some examples, the bearing supports may be tubular elements with an internal diameter greater than the external diameter of the shaft 110. The shaft 110 may thus rotate within the tubular elements. The inner surface of the tubular elements may comprise materials with a low frictional coefficient. In some examples, ball bearings may be defined between the external diameter of the shaft 110 and the bearing support.

In other examples, the bearing supports may comprise an inner ring and an outer ring. The inner ring may rotate about the outer ring. The inner ring may be fixedly connected to the shaft 110. For example, the inner ring may clamp the shaft 110. In these examples, the outer ring may be connected to the blade structure in a slidable manner. For example, a connecting structure 130 according to any of the examples herein disclosed may be used to connect the outer ring to the blade structure.

The bearing supports may be supported by a support plate. The support plate may extend from the pressure side to the suction side of the blade. The support plate may comprise a curved shape. For example, the support plate may comprise a plurality of curved segments. In some examples, the support plate comprises a pressure side curved segment spanning from the bearing support to the pressure side and a suction side curved segment spanning from the bearing support to a suction side. These two curved segments may comprise s-shaped segments, e.g. double s-shaped segments. This type of supporting plate may reduce the adverse effect of the deflections of the blade on the bearing supports. Consequently, bending and axial loads acting on the shaft and on the support bearings may thus be minimized. The friction in the bearing supports may thus be consequently reduced which may result in improving both the measurement accuracy and the lifetime of the wind turbine blade torsion measuring system.

FIG. 6 schematically represents a wind turbine blade torsion measuring system 100 according to an example of the present disclosure. The wind turbine blade torsion measuring system 100 may be as described with respect to the example of FIG. 5; however, in FIG. 6, the second shaft portion 112 is connected to a second rotary sensor assembly 120a, rather than being rigidly connected to the blade structure as in FIG. 5.

In FIG. 6, the second rotary sensor assembly 120a is rigidly connected to the blade structure. The second rotary sensor assembly 120a may be according to any of the examples herein disclosed. The second shaft portion 112 of this figure is rigidly connected to the rotating component of the second rotary sensor assembly 120a and the fixed component is rigidly connected to the blade structure.

However, in other examples, the second rotary sensor assembly 120a may be movably connected, e.g. slidably connected, to the blade structure through a second connecting structure. The second connecting structure may be a connecting structure according to any of the examples herein disclosed. In these examples, an axial stopper may be provided in any of the connecting structures to counteract the centrifugal forces.

In the example of FIG. 6, the fixed component of the rotary sensor assemblies 120 and 120a rotates together with the blade structure. Accordingly, torsional deformation of the blade 7 causes a rotational movement of the fixed component of the rotary sensor assemblies 120 and 120a. As the torsional deformation of the blade increases with the distance from the root, the rotation of the fixed component of the second rotary sensor assembly 120a is greater than that of the rotary sensor assembly 120. The rotating components can rotate about the fixed components of the rotary sensor assemblies 120 and 120a. Accordingly, the rotation of the fixed components does not cause the rotation of the rotating components. The rotating components remain substantially in a fixed position when the blade 7 experiences a torsional deformation. The fixed components of this example thus rotate about the rotating components. The sensors may detect the relative movement between the rotating components and the fixed components of each rotary sensor assembly. A difference between the rotational movement detected by the second rotary sensor assembly 120a and by the rotary sensor assembly 120 indicates the torsional deformation of the blade between these points.

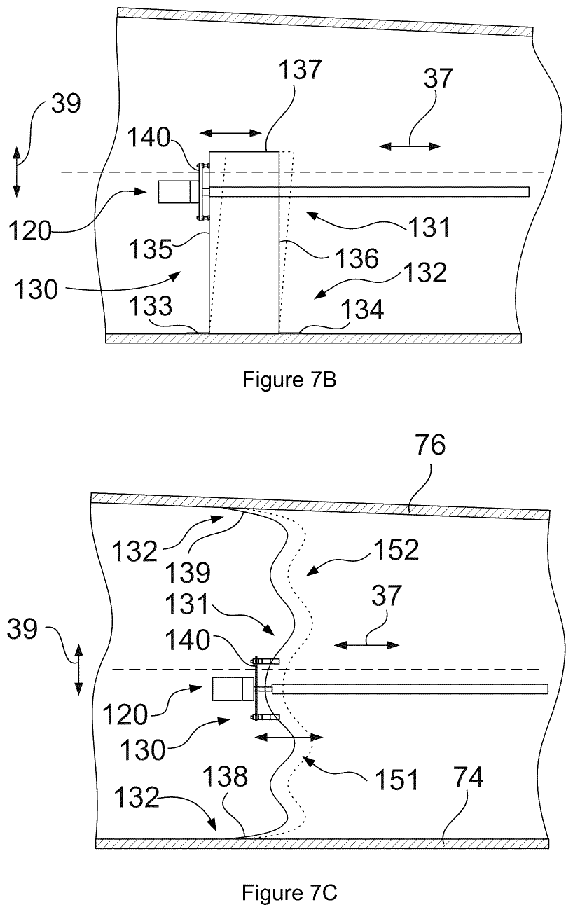

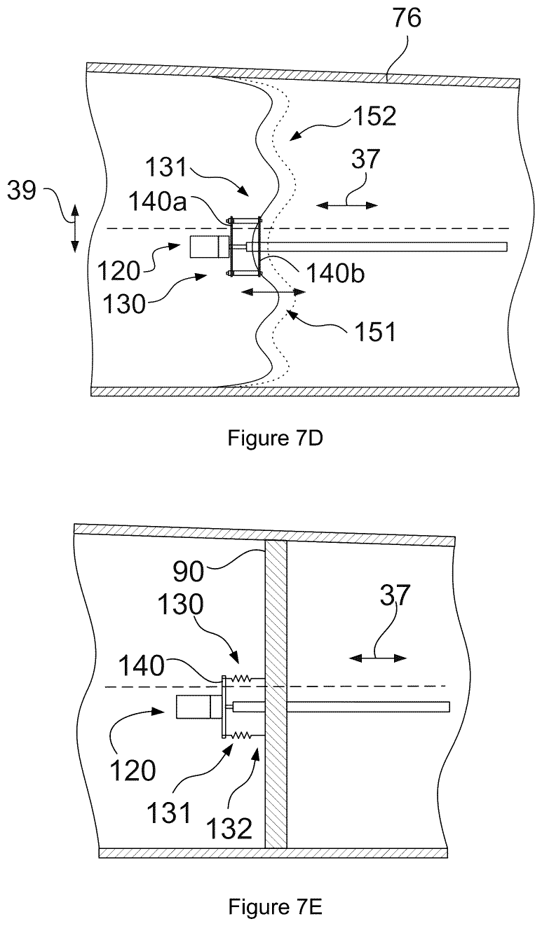

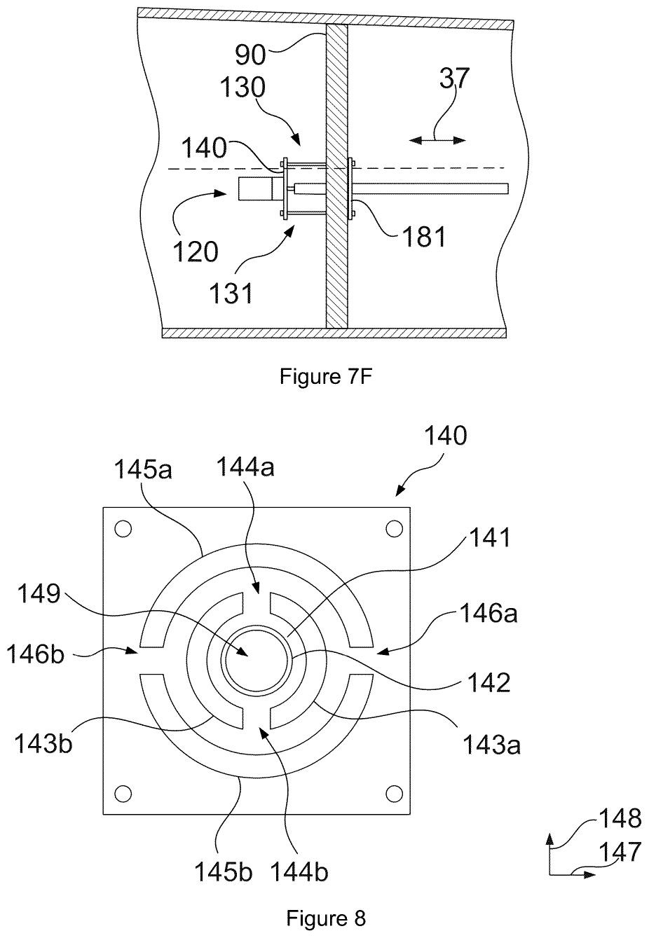

FIG. 7a-7f schematically represents examples of a rotary sensor assembly and a connecting structure according to the present disclosure.

In FIG. 7a, the connecting structure 130 comprises an outer portion 132 rigidly connected to the blade structure. The outer portion 132 may be connected to the shear web and/or to a rib structure of the blade structure. Bolts, e.g. nylon bolts, may be used for rigidly connecting the outer portion 132 to the blade structure.

In some examples, the outer portion 132 comprises a suction side outer portion configured to be connected to a suction side shear web of the blade structure and a pressure side outer portion configured to be connected to a pressure side shear web of the blade structure. The connecting structure may thus extend along a direction parallel to the flapwise direction 39.

In this example, the connecting structure 130 further comprises a deformable portion 131. The deformable portion 131 is connected to the rotary sensor assembly 120. As can be seen in FIG. 7a, the deformable portion 131 is configured to deform under a load in a direction parallel to the shaft 110, e.g. parallel to the spanwise direction 37 of the wind turbine blade. The rotary sensor assembly 120 may thus move relative to the blade structure in a direction substantially parallel to the spanwise direction 37 when the first shaft portion 111 is coupled to the blade structure of the wind turbine blade.

In this example, the deformable portion 131 is a flat plate. The flat plate of this figure extends in a direction substantially parallel to the flapwise direction 39 of the wind turbine blade and is configured to bend about a direction substantially parallel to the edgewise direction of the wind turbine blade. The flat plate may bend under a load about a direction substantially parallel to the edgewise direction of the wind turbine blade. The flat plate may comprise a thickness that allows bending but also maintaining the rotary sensor assembly 120 at a specific position along the flapwise and/or the edgewise direction.

An aperture may be provided on the flat plate to allow the first shaft portion 111 of the shaft 110 to be connected to the rotating component 121 of the rotary sensor assembly 120. The rotary sensor assembly 120 of this example may be according to any of the examples herein disclosed.

Due to the compensation for the bending and thermal expansion, the shaft 110 may be mounted below the flap neutral axis 40 without adversely affecting the precision of the rotation measurement.

In the example of this figure, the rotary sensor assembly 120 pivotally and/or slidably coupled to the connecting structure 130. This enhances the compensation for the bending and/or thermal expansions of the blade and/or the shaft.

The rotary sensor assembly 120 of this figure comprises a sensor plate 140 arranged substantially perpendicular to the shaft 110. The sensor plate 140 is rotatably connected to the rotating component 121. The sensor plate of this example is fixedly connected to the deformable portion 131 of the connecting structure 130. A bearing may be provided to rotatably connect the rotating component 121 to the sensor plate 140. In other examples, the sensor plate 140 may be connected to the fixed component 122. The sensor plate 140 of this figure can deform under a load to move the fixed component 122 and the rotating component 121 relative to the connecting structure 130. Spacers may be provided at the corners of the sensor plate 140 to allow the central portion of the sensor plate to deform towards the flat plate of the connecting structure 130. The sensor plate of this example allows the assembly formed by the fixed component 122 and the rotating component 121 to pivot about a direction substantially parallel to the edgewise direction and/or to about a direction substantially parallel to the flapwise direction 39. Soft or weak zones may be provided to facilitate the deformation of the sensor plate 140. The soft zones may be arranged around the central portion of the sensor plate 140.

In other examples, the rotary sensor assembly 120 comprises a plurality of deformable elements extending in a direction substantially parallel to the shaft 110. These deformable elements may connect the fixed component 122 of the rotary sensor assembly 120 to the connecting structure 130. The rotary sensor assembly 120 may thus pivot and/or slide over the connecting structure 130.

Similar to the connecting structure 130 of FIG. 7a, the connecting structure 130 of FIG. 7b also comprises an outer portion 132 rigidly connected to the blade structure and a deformable portion 131 to permit a movement of the rotary sensor assembly 120 relative to the blade structure.

The outer portion 132 of FIG. 7b comprises a root side outer portion 133 and a tip side outer portion 134. In this example, the root side outer portion 133 and the tip side outer portion 134 are connected to a pressure side spar cap 74, e.g. by bonding. However, in other examples, the outer portion 132 may be connected to the suction side spar cap. In this figure, the deformable portion 131 comprises a root side flat plate 135 extending from the root side outer portion 133 and a tip side flat plate 136 extending from the tip side outer portion 134. The tip side flat plate 136 is substantially parallel to the root side flat plate 135. These flat plates extend in a direction substantially parallel to the flapwise direction 39. An upper plate 137 connects the tip side flat plate 136 to the root side flat plate 135. The connecting structure 130 of this figure thus forms a U-shaped profile. The U-shaped profile may be manufactured from biaxial fibers to allow the deformations and to avoid stress concentrations.

In the example of FIG. 7b, the rotary sensor assembly 120 is connected to the root side flat plate 135, specifically in an upper portion of the root side flat plate 135. This position may cause the bending of the root side flat plate 135 and the tip side flat plate 136 about an edgewise direction. The rotary sensor assembly 120 may thus be moved in a direction parallel to the spanwise direction 37. In other examples, the rotary sensor assembly 120 may be connected to the tip side flat plate 136.

The rotary sensor assembly 120 of this figure comprises a sensor plate 140 rotatably connected to the rotating component. However, in other examples, the fixed component may be rigidly connected to the sensor plate. The sensor plate 140 may be according to any of the examples herein disclosed. For example, the sensor plate 140 may allow a movement of the rotary sensor assembly relative to the connecting structure 130.

In FIG. 7c, the deformable portion 131 of the connecting structure 130 comprises a plurality of curved segments. These curved segments induce the deformation of the deformable portion 131 in a direction substantially parallel to the spanwise direction 37 while providing sufficient stiffness to maintain the rotary sensor assembly 120 in a specific position along the flapwise direction 39 and/or the edgewise direction. The deformable portion 131 of this figure is thus a plate formed by curved segments or parts.

The deformable portion 131 comprises several curvatures arranged in the flapwise direction 39. These curvatures may be deformed about the edgewise direction. These curvatures may be formed by S-shaped segments and/or multiple s-shaped segments, e.g. double s-shaped segments. In the example of FIG. 7c, the curved plate comprises two double s-shaped segments: a pressure side double s-shaped segment 151 and a suction side double s-shaped segment 152 joined together at the central region of the deformable portion 131. The rotary sensor assembly 120 of this example is connected to the central portion.

In this example, the outer portion 132 is connected to the spar cap of the blade structure. The pressure side double s-shaped segment 151 ends at a pressure side outer portion 138 and the suction side double s-shaped segment 152 ends at a suction side outer portion 139. The pressure side outer portion 138 is connected to the pressure side spar cap 74 and the suction side outer portion 139 is connected to the suction side spar cap 76.

In FIG. 7c, the suction side outer portion 139 and the pressure side outer portion 138 substantially extend towards the root portion of the blade. The outer portions 132 may bend over the deformable portion 131. Distance between these outer portions may be adjusted. This distance may thus be adjusted to the distance between the pressure side spar cap 74 and the suction side spar cap 76. Changes in the thickness of the spar caps and/or inner rugosity of the blade may thus be compensated. Assembling and installation of the blade torsion measurement system may thus be simplified. The outer portions 132 of this example may apply pressure against the spar cap to fix the connecting structure 130 at a specific position.

In this figure, the sensor plate 140 is arranged at the root side of the deformable portion 131. In other examples, the sensor plate may be arranged at the tip side of the deformable portion 131.

The sensor plate 140 may be configured to allow the rotary sensor assembly to move relative to the connecting structure 130.

In further examples, a first sensor plate may be arranged at the root side and a second sensor plate at the tip side of the deformable portion 131. The stability of the rotary sensor assembly 120 may thus be increased. The first and the second sensor plate may also be configured to deform when a load is applied.

In FIG. 7d, the connecting structure 130 is according to the connecting structure of FIG. 7c. In particular, the deformable portion 131 of this example comprises a plurality of curved segments. As in the example of FIG. 7c, the rotary sensor assembly 121 of FIG. 7e is connected to a central portion arranged between a pressure side double s-shaped segment 151 and a suction side double s-shaped segment 152.

The rotary sensor assembly of this figure comprises a first sensor plate 140a and a second sensor plate 140b. The sensor plates 140a and 140b may be according to any of the herein examples. For example, the first sensor plate 140a may be according to the sensor plate 140 of FIG. 7c. The first sensor plate 140a is arranged at the root side and the second sensor plate 140b at the tip side of the deformable portion 131.

The rotary assembly 120 of this example is connected to the first sensor plate 140a according to any of the herein examples. The first sensor plate 140a is connected to the second sensor plate 140b. A plurality of spacers is arranged between the first sensor plate 140a and the second sensor plate 140b. Bolts may be used to connect the first sensor plate 140a to the second sensor plate 140b. These bolts may be arranged inside the spacers. These bolts may additionally be used to connect the second sensor plate 140b to the deformable portion 131 of the connecting structure. The deformable portion, e.g. the central portion, may thus be sandwiched between the sensor plates 140a and 140b. The second sensor plate 140b of this example is rotatably connected to the shaft.

The stability of the rotary sensor assembly 120 may thus be increased while decoupling the deflections of the blade with respect to the torsion of the rod may be further improved.

In the example of FIG. 7e, the connecting structure 130 is connected to a blade rib structure 90. Blade rib structure may be provided along the length of the blade. These blade rib structures 90 may increase the local stiffness of the blade.

The connecting structure 130 of this example comprises an outer portion 132 rigidly connected to the blade rib structure 90. The deformation portion 131 is arranged between the sensor plate 140 and the outer portion 132. The deformation portion 131 may comprise a plurality of deformable elements extending in a direction substantially parallel to the spanwise direction 37. Springs or deformable plates, e.g. ZZ-shaped plates, may be examples of deformable elements to movably connect the rotary sensor assembly to the blade structure in a direction substantially parallel to the spanwise direction 37, e.g. to the blade rib structure 90. The sensor plate 140 may be according to any of the examples herein.

The example of FIG. 7f is similar to the example of FIG. 7e. However, the connecting structure 130 of the example of FIG. 7f comprises a deformable plate 181. The deformable plate 181 may be according to the sensor plate 140 according to any of the examples herein. The blade rib structure 90 is arranged between the sensor plate 140 and the deformable plate 181. The sensor plate 140 is connected to the deformable plate 181 through the blade rib structure 90. Bolts may pass through the blade rib structure to connect sensor plate 140 and the deformable plate 181. The connection of the rotary sensor assembly 120 to the connecting structure 130 may thus be further enhanced.

FIG. 8 schematically represents a sensor plate according to any of the examples herein disclosed. The sensor plate 140 of this figure is square-shaped. However, the sensor plate may comprise any other suitable shape.

The sensor plate 140 comprises a central portion 141. The rotating component may be connected to the central portion 141 of the sensor plate 140. In this example, a sensor plate bearing 142 is arranged at the central portion 141. The sensor plate bearing 142 comprises an inner ring and an outer ring. The inner ring may rotate about the outer ring. Roller elements, such as ball bearings may be arranged therebetween. The inner ring may be rigidly connected to the shaft and/or to the rotating component. The inner ring defines a central aperture 149 to receive the shaft and/or the rotating component. In this example, the outer ring is rigidly connected to the sensor plate and the inner ring to the shaft.

However, in other examples, the fixed component is rigidly connected to the sensor plate 140. In these examples, the central aperture 149 of the central portion 141 is configured to allow the shaft and/or the rotating component to pass through it.

In this example, holes are provided at each of the corners of the sensor plate 140. Fasteners, e.g. bolts or screws, may be inserted into the holes and secured to the deformable portion of the connecting structure. The sensor plate 140 extends a first length along a first direction 147 and a second length along a second direction 148. The sensor plate 140 may be manufactured from glass-reinforced plastic.

The sensor plate 140 of this example comprises a plurality of apertures around the central portion 141. These apertures weaken the stiffness of the sensor plate 140 to allow the sensor plate to deform in a direction perpendicular to the first direction 147 and to the second direction 148. When mounted inside the wind turbine blade, the sensor plate 140 may deform in a direction parallel to the spanwise direction.

In this figure, the plurality of apertures comprises arc-shaped apertures. In other examples, the apertures may comprise any other suitable shape. In this figure, a pair of arc-shaped inner apertures 143a and 143b are arranged around the central portion 141. The arc-shaped inner apertures 143a and 143b of this example extend between 150 and 178 degrees. The arc-shaped inner apertures are symmetrically arranged relative to the central aperture 149. Connecting bridges 144a and 144b are arranged between the arc-shaped inner apertures. In this example, the upper connecting bridge 144a is arranged between the upper ends of the arc-shaped inner apertures 143a and 143b and the lower connecting bridge 144b is arranged between the lower ends of the arc-shaped inner apertures 143a and 143b. The inner bridges and the arc-shaped inner apertures of this figure define a circular shape around the central aperture 149. In other examples, the arc-shaped apertures may define an elliptical shape.

In this example, a pair of arc-shaped outer apertures 145a and 145b are arranged around, e.g. concentrically, the arc-shaped inner apertures 143a and 143b. Connecting bridges 146a and 146b are arranged between the arc-shaped outer apertures 145a and 145b. The arc-shaped outer apertures 145a and 145b of this example are rotated 90 degrees relative to the arc-shaped inner apertures 143a and 143b. In other examples, the arc-shaped outer apertures 145a and 145b may be rotated relative to the arc-shaped inner apertures 143a and 143b according to any suitable angle.

This plurality of apertures, e.g. arc-shaped apertures, allows the sensor plate 140 to deform in a direction perpendicular to the first direction 147 and to the second direction 148. The misalignment of the apertures further allows the sensor plate to bend about a direction perpendicular to the first direction 147 and/or to the second direction 148. The flexibility of the wind turbine blade torsion measuring system is thus improved. Compensation for the bending or thermal expansion of the blade and/or the shaft is thus enhanced. This sensor plates 140 may thus act as a cardan arrangement as is configured to axially deform in a direction perpendicular to the plane defined by the first direction 147 and the second direction 148; and to bend about a direction perpendicular to the first direction 147 and/or to the second direction 148, while the rotation of the sensor plate 147 is prevented.

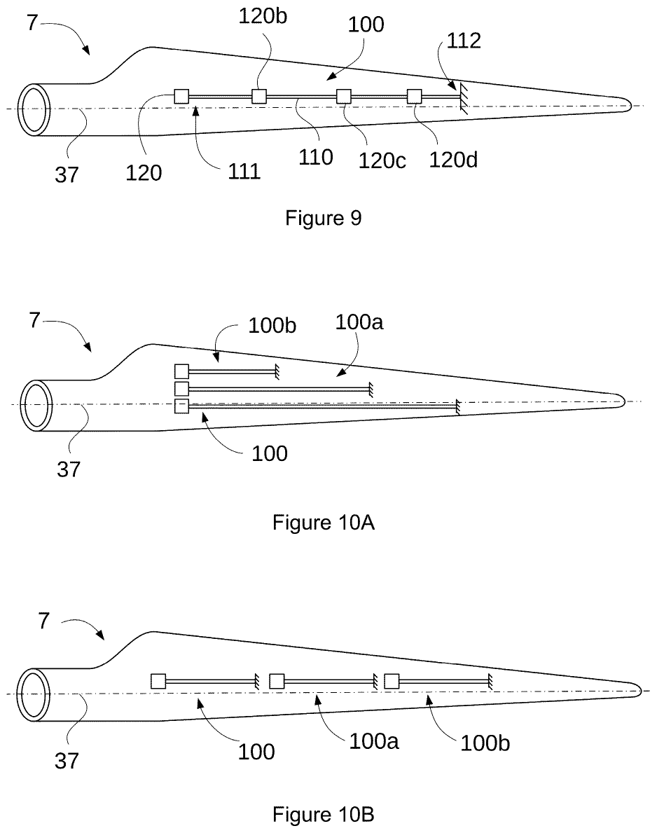

FIG. 9 schematically represents a wind turbine blade torsion measuring system arranged within a wind turbine blade 7 according to an example of the present disclosure. As the example of FIG. 5, the shaft 110 comprises a first shaft portion 111 coupled to a rotary sensor assembly 120 and a second shaft portion 112 rigidly or fixedly coupled to the blade structure.

The wind turbine blade torsion measuring system 100 may comprise one or more additional rotary sensor assemblies. Torsional deformation of the blade 7 may thus be measured at different locations along the length of the blade. Measurement accuracy is thus improved. Furthermore, gradient torsional deformation between different rotary sensor assemblies may also be obtained. Local effects may thus be determined.

In this example, the blade torsion measuring system comprises three additional rotary sensor assemblies 120b, 120c and 120d. In other examples, the number of rotary sensor assemblies may vary. These additional rotary sensor assemblies are arranged between the first shaft portion 111 and the second shaft portion 112. The rotating component of each of these additional rotary sensor assemblies 120b, 120c and 120d is fixedly connected to the shaft 110.

The rotary sensor assemblies of these figures may be according to any of the examples herein disclosed. In some examples, the one or more additional rotary sensor assemblies are movably coupled to the blade structure through a connecting structure according to any of the examples herein disclosed. In further examples, some of the one or more additional rotary sensor assemblies are directly connected to the blade structure.

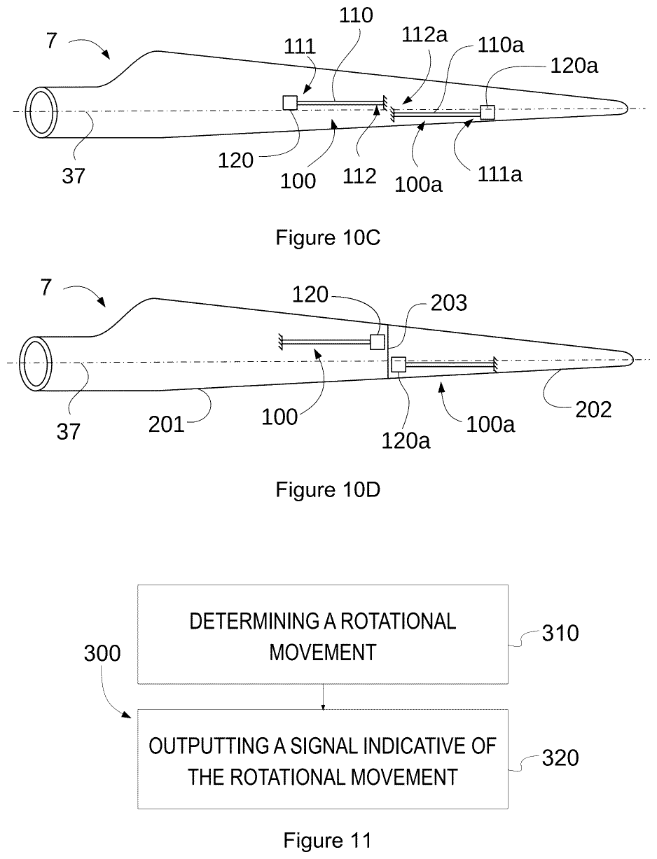

FIGS. 10a-10d schematically represent examples of wind turbine blades having a plurality of wind turbine blade torsion measuring systems according to the present disclosure. The wind turbine blade torsion measuring systems of these examples may be according to any of the examples herein disclosed. The plurality of wind turbine blade torsion measuring systems may be arranged within a cavity defined by two parallel shear webs. In further examples, the wind turbine blade torsion measuring systems may be arranged at the leading edge cavity and/or on the trailing edge cavity.

The plurality of wind turbine blade torsion measuring systems 100, 100a and 100b of FIG. 10a are arranged substantially parallel in the spanwise direction 37 of the wind turbine blade 7. The length of the shafts may vary to detect the torsional deformation of the blade 7 at different locations. In this example, the rotary sensor assemblies are arranged on the root side end of the corresponding shaft. The rotary sensor assemblies of this figure are arranged substantially at the same length of the blade. In other examples, the rotary sensor assemblies may be arranged at different lengths of the blade.

In this example, the shafts of the wind turbine blade torsion measuring systems extend from the corresponding rotary sensor assemblies towards the tip end of the blade. In other examples, one or more of the shafts may extend from the corresponding rotary sensor assemblies towards the root end of the blade.

In FIG. 10b, the plurality of wind turbine blade torsion measuring systems 100, 100a and 100b are arranged in succession in the spanwise direction 37 of the wind turbine blade 7. This configuration may provide partial measurements of the torsional deformation. The absolute torsional deformation may be obtained by adding the partial measurements provided by each of the wind turbine blade torsion measuring systems 100, 100a and 100b.

In some examples, the shafts of the wind turbine blade torsion measuring systems may partially overlap. Partial torsional deformation for each wind turbine blade torsion measuring system may be used for determining the absolute torsional deformation.

In the example of FIG. 10c the blade torsion blade measuring systems are arranged at the outermost half portion of the blade. The wind turbine blade torsion measuring system 100 is arranged closer to the root than the wind turbine blade torsion measuring system 100a. The first shaft portion 111 of the shaft 110 faces the root of the blade and the second shaft portion 112 faces the tip portion of the blade. On the contrary, the first shaft portion 111a faces the tip portion of the blade and the second shaft portion 112a faces the root of the blade. The second shaft portions 112 and 112a faces each other. The second shaft portions 112 and 112a may be connected to a single blade component. In other examples, the orientation of the blade torsion blade measuring systems may be different.

In this example, the wind turbine blade torsion measuring system 100 is arranged at the trailing edge cavity and the wind turbine blade torsion measuring system 100a is arranged at the leading edge cavity.

The rotary sensor assemblies 120 and 120a may be connected to a connecting structure according to any of the examples herein. For example, the rotary sensor assembly 120 may be connected to the connecting structure according to the example of FIG. 7c or 7d; and the rotary sensor assembly 120a may connected to the connecting structure according to the example of FIG. 7e or 7f.

The blade 7 of FIG. 10 d is a segmented blade. A first blade segment 201 is joined to a second blade segment 202 through a blade joint 203. The blade joint 203 may comprise a plurality of connectors and one or more fairings covering the connectors. In this example, the first blade segment 201 comprises a first wind turbine blade torsion measuring system 100 and the second blade segment 202 comprises a second wind turbine blade torsion measuring system 100a. In this example, the rotary sensor assemblies 120 and 120a face the blade joint 203. The rotary sensor assemblies 120 and 120a are adjacent to the blade joint 203. The rotary sensor assemblies 120 and 120a may be accessible through the fairing. Maintenance and inspection of the rotary sensor assemblies may thus be easily performed.

The wind turbine blade torsion measuring systems 100 and 100a may be according to any of the examples herein.

FIG. 11 is a block diagram of a method of determining a torsional deformation of a wind turbine blade comprising one or more wind turbine blade torsion measuring system according to an example of the present disclosure.

The wind turbine blade torsion measuring system may be according to any of the examples herein disclosed. The method 300 comprises determining a rotational movement of the rotating component relative to the fixed component of the corresponding rotary sensor assembly as represented at block 310. The relative rotational movement between the rotating component and the fixed component is measured according to any of the examples herein disclosed.

At block 320, outputting a signal indicative of the determined rotational movement to a controller is represented. In some examples, the controller may comprise a data acquisition system. Wiring connections and/or wireless connections may be used to communicatively couple the rotary sensor assembly or the plurality of sensor assemblies to a controller.

In some examples, the method may comprise determining a plurality of rotational movements, each of them corresponding to a different rotary sensor assembly. These different rotary sensor assemblies may belong to a single wind turbine blade torsion measuring system or to a plurality of wind turbine blade torsion measurement systems.

In these examples, the method may further comprise determining a torsional deformation of the wind turbine blade at different positions along the spanwise direction of the blade.

In some examples, the method may further comprise comparing a rotational movement between the rotating component and the fixed component of a rotary sensor assembly with an expected value. The expected value may be selected for given conditions, e.g. for a specific wind speed and/or pitch angle. Depending on the result, a load mitigation strategy may be activated.

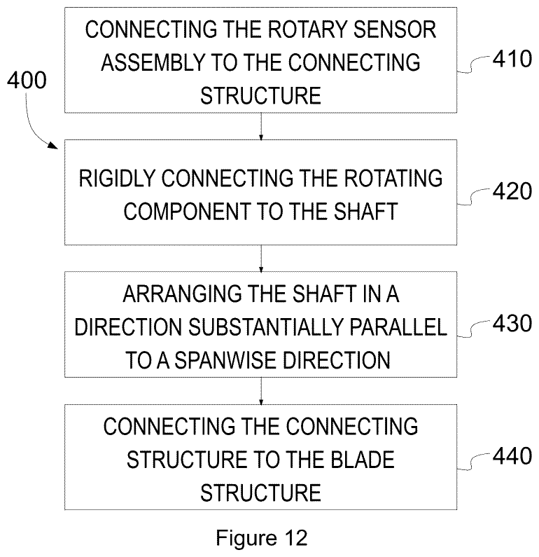

FIG. 12 is a block diagram of a method for mounting a wind turbine blade torsion measurement system in a wind turbine blade according to an example of the present disclosure.

The method 400 comprises connecting the rotary sensor assembly to the connecting structure, as represented at block 410. For example, the fixed component of the rotary sensor assembly may be rigidly or fixedly connected to the connecting structure. In other examples, the rotating component may be rotatably connected to the connecting structure.

In some examples, connecting the rotary sensor assembly to the connecting structure comprises connecting a sensor plate to the rotary sensor assembly and to the connecting structure according to any of the examples herein disclosed.

At block 420, rigidly connecting the rotating component of the rotary sensor assembly to the first shaft portion is represented. The first shaft portion may be clamped by the rotating component. Other suitable connection methods such as welding, bolting and/or snap fitting may also be suitable.

In some examples, the rotating component may be connected to the first shaft portion before connecting the rotary sensor assembly to the connecting structure. In other examples, the rotary sensor assembly is first connected to the connecting structure and then the shaft is connected to the rotating component.

Arranging the shaft in a direction substantially parallel to a spanwise direction of the wind turbine blade is represented at block 430. In some examples, arranging the shaft in a direction substantially parallel to the spanwise direction may comprise inserting the shaft within the wind turbine blade. In some examples, the shaft rigidly connected to the rotating component may be inserted into the wind turbine blade. In other examples, the shaft may be inserted in the wind turbine blade and then connected to the rotating component.

In some examples, inserting the shaft within the blade turbine blade comprises pushing the shaft in a direction parallel to the spanwise direction of the blade. The shaft may be pushed inside a cavity formed between two shear webs.

At block 440, connecting the connecting structure to the blade structure is represented. The connecting structure may be connected to the blade structure according to any of the examples herein disclosed. For example, the connecting structure may comprise a bendable pressure side outer portion and a bendable suction side outer portion. These outer portions may apply pressure against the spar cap to retain the connecting structure at a predetermined position.

Blocks 410, 420, 430 and 440 disclosed herein are not constrained to a particular order. In some examples, the shaft, the rotary sensor assembly and the connecting structure are inserted together into the wind turbine blade. This may reduce the number of operations and connections to be performed inside the blade.

The method may further comprise connecting the shaft to the blade structure. Snap-fit connections or adhesive may be used for connecting the shaft to the blade structure.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1.-15. (canceled)

16. A wind turbine blade torsion measuring system, comprising:
a shaft configured for arrangement in a direction substantially parallel to a spanwise direction of a wind turbine blade, the shaft comprising a first shaft portion configured to couple to a blade structure of the wind turbine blade;
a rotary sensor assembly comprising:
a rotating component rigidly connected to the first shaft portion;
a fixed component, the rotating component rotatably connected to the fixed component; and
a sensor that determines a rotational movement of the rotating component relative to the fixed component;
a connecting structure configured to movably connect the rotary sensor assembly to the blade structure to allow a relative movement between the rotary sensor assembly and the blade structure in a direction substantially parallel to the spanwise direction of the wind turbine blade.

17. The wind turbine blade torsion measuring system according to claim 16, wherein the connecting structure comprises:
an outer portion configured to rigidly connect to the blade structure; and
a deformable portion connected to the rotary sensor assembly and configured to deform under a load in a direction parallel to the shaft to move the rotary sensor assembly relative to the blade structure in a direction substantially parallel to the spanwise direction of the wind turbine blade when the first shaft portion is coupled to the blade structure of the wind turbine blade.

18. The wind turbine blade torsion measuring system according to claim 17, wherein the deformable portion comprises a plurality of curved segments.

19. The wind turbine blade torsion measuring system according to claim 18, wherein the deformable portion comprises an S-shaped segment or a multi S-shaped segment.

20. The wind turbine blade torsion measuring system according to claim 16, wherein the rotary sensor assembly is pivotally or slidably coupled to the connecting structure.

21. The wind turbine blade torsion measuring system according to claim 20, wherein the rotary sensor assembly comprises a sensor plate arranged substantially perpendicular to the shaft; the sensor plate rotatably connected to the rotating component and fixedly connected to the connecting structure, and wherein the sensor plate is configured to deform under a load to move the fixed component and the rotating component relative to the connecting structure.

22. The wind turbine blade torsion measuring system according to claim 21, wherein the rotating component is connected to a central portion of the sensor plate, and wherein the sensor plate comprises a plurality of apertures disposed around the central portion.

23. The wind turbine blade torsion measuring system according to claim 16, further comprising one or more bearing supports to rotatably connect the shaft to the blade structure.

24. The wind turbine blade torsion measuring system according to claim 16, wherein the shaft comprises a second shaft portion that fixedly couples to the blade structure.

25. A wind turbine blade, comprising at least one wind turbine blade torsion measuring system according to claim 16.

26. The wind turbine blade according to claim 25, comprising a plurality of the wind turbine blade torsion measuring systems.

27. The wind turbine blade according to claim 26, wherein the plurality of wind turbine blade torsion measuring systems are serially arranged in the spanwise direction of the wind turbine blade.

28. The wind turbine blade according to claim 26, wherein the plurality of wind turbine blade torsion measuring systems are arranged substantially parallel to each other in the spanwise direction of the wind turbine blade.

29. A method of determining a torsional deformation of a wind turbine blade configured with at least one wind turbine blade torsion measuring system according to claim 16, the method comprising:
determining a rotational movement of the rotating component relative to the fixed component of the rotary sensor assembly; and
outputting a signal indicative of the determined rotational movement to a controller.

30. A method for mounting the wind turbine blade torsion measuring system according to claim 16 to a wind turbine blade, the method comprising:
connecting the rotary sensor assembly to the connecting structure;
rigidly connecting the rotating component of the rotary sensor assembly to the first shaft portion;
arranging the shaft in a direction substantially parallel to the spanwise direction of the wind turbine blade; and
connecting the connecting structure to the blade structure.
